(19) United States
(12) Patent Application Publication
(10) Pub. No.: US 2004/0038605 A1
(43) Pub. Date: Feb. 26, 2004

(54) Material and process for self-regulating temperature, wickability, flame- , biological-agent-, and soil-resistant controlled yarn, substrate or fabric

(76) Inventor: Douglas L. Hooper, Oak Ridge, NC (US)

Correspondence Address: KENYON & KENYON, 1500 K STREET, N.W., SUITE 700, WASHINGTON, DC, 20005, US

(21) Appl. No.: 10/318,075

(22) Filed: Dec. 13, 2002

Related U.S. Application Data
(60) Provisional application No. 60/350,843, filed on Jan. 24, 2002.

(51) Int. Cl. B32B 5/02

(52) U.S. Cl. 442/59

(57) ABSTRACT

A product with but not limited to properties of wickability, soil release, moisture control and/or absorption, resistance to static charges, abrasion resistance, pilling resistance, fire retardancy, durable press, resistance to the growth of microbes, funguses, and microscopic parasites.

### BACKGROUND OF THE INVENTION

We describe a process for imparting self-regulating properties of temperature and qickability control, as well as flame, biological-agent and soil resistance to yarns, substrates and fabrics, whether or not originally hydrophobic or hydrophilic.

### DESCRIPTION OF THE INVENTION

A textile yarn, substrate or finished fabric of fiber substrate (non-woven, woven or knitted) is treated with a solution of (optionally) Hydrolon®; and an organic acid (e.g. Citric acid or phosphoric acid), dihydroxy dimethylol ethylene una (DMDHEU) or other trifunctional or greater functionality cross-linking agents, Polyethylene Glycol (PEG), silicone or fatty acid softeners, and water. The resulting product is a yarn, substrate or fabric with controlled wettability, porosity, and cross-linked molecular structure.

For different applications soda ash may be employed as a neutralization agent, as well as glyxol resin, tridecyl alcohol hydrogen peroxide 35% as a whitener, and/or PEG1450. Each of the above individually is a commercially-available product optionally incorporated in or used for the purposes of the product described herein.

In the preferred embodiment: Chemicals described above, in prescribed amounts are diluted and fed into the wet-out tank of a padding (squeezing) mangle. A low volume in the wet-out tank is maintained at a controlled level during the process.

A foam generator using the attached “With Foam” formula can be used in lieu of the padding mangle. In this case the substrate is fed through the foam generator and into the continuous drying and curing oven. This method allows faster processing speeds due to less drying time being required.

The yarn or substrate is threaded through the solution in the wet-out tank and squeezed between the rolls of the padding mangle to maintain a wet pick-up on the goods of 100% of the basis weight of the yarn or substrate. This is accomplished by maintaining control pressure on the squeezing rolls via air cylinders with pneumatic controllers.

The yarn or substrate is threaded from the pad mangle through a multi-pass or long dwell time continuous dryer or Tenter frame where the solution is dried onto the yarn or substrate and cured for a minimum of 90 seconds at 210° F.-230° F. The temperature must be closely maintained due to the volatility of the PEG at a temperature above 230° F.

The yarn, fabric or substrate is then washed through continuous washers and neutralized in the second washer with a 2% solution of soda ash and water:

The yarn, fabric or substrate is then re-dried through a relaxed dryer or tenter frame to remove the water from the substrate.

Mechanical processing of some types of substrates to impart the proper feel to the finished product can follows this step. This processes could include but is not limited to the following:

Tumbling

Relaxed Drying

Continuous Tumbling

Napping or brushing the surface

Continuous impact processing.

At this point the yarn, fabric or substrate is properly treated and will have combined with the necessary chemicals described above to exhibit the properties desired.

### REFERENCES

U.S. Pat. No. 5,928,971 Ellis, et al. Jul. 27, 1999

U.S. Pat. No. 5,787,503 Murphy, III Aug. 4, 1998

U.S. Pat. No. 6,225,403 Knowlton May 1, 2001

U.S. Pat. No. 6,238,441 Wallace, et al. May 29, 2001

We claim:

1. A product with but not limited to properties of wickability, soil release, moisture control and/or absorption, resistance to static charges, abrasion resistance, pilling resistance, fire retardancy, durable press, resistance to the growth of microbes, funguses, and microscopic parasites.

2. A product having the properties of one or more of the features of claim 1.

3. A cloth or yarn, woven, non-woven or knitted having all or some of the properties of claims 1 or 2.
